(19) United States
(12) Patent Application Publication
(10) Pub. No.: US 2014/0136329 A1
(43) Pub. Date: May 15, 2014

(54) User Interface For Vehicular-Based Mobile Payment System And Method

(71) Applicant: Maximilian A. Chang, Saratoga, CA (US)

(72) Inventor: Maximilian A. Chang, Saratoga, CA (US)

(21) Appl. No.: 13/674,927

(22) Filed: Nov. 12, 2012

(51) Int. Cl. G06Q 20/08; G06Q 40/02

(52) U.S. Cl. CPC G06Q 20/08; G06Q 30/0265; G06Q 30/0641; G06Q 40/02
USPC 705/14.62; 705/39; 705/27.1; 705/34

(57) ABSTRACT

A user interface for a vehicular-based mobile payment system, the vehicular-based mobile payment system comprising: a merchant system for sending and receiving information; a vehicle detection system connected to the merchant system; a vehicle comprising a mobile payment extension system, wherein the mobile payment extension system is adapted to communicate with the merchant system via the vehicle detection system; and a mobile device for sending and receiving information, wherein the mobile device is adapted to communicate with the mobile payment extension system of the vehicle, where a user communicates with the mobile device via the user interface displayed on the mobile device. Also, a method and a non-transitory computer-readable storage medium related to the user interface for the vehicular-based mobile payment system.

### CROSS REFERENCE TO RELATED APPLICATIONS

This application is related to co-pending U.S. patent application Ser. No. ______, entitled “Vehicular-Based Mobile Payment System And Method,” filed Nov. 12, 2012, in the name of the same inventor and commonly owned herewith.

### TECHNICAL FIELD

The present invention relates to systems and methods associated with mobile payment technology, particularly mobile payment technology incorporated into a motor vehicle to permit exchange of information, which can include payment information, between two parties. The two parties can include, for example, a merchant and a customer driving a vehicle through the merchant's drive-through lane. In a preferred embodiment, the system and method can include Near Field Communications (NFC) technology. The present invention also relates to a user interface for the systems and methods.

### BACKGROUND OF THE INVENTION

Mobile payment transactions are well known in the art and are enabled by short-range wireless technologies such as Near Field Communications (NFC). NFC is a set of standards for communication protocols which enable NFC compliant devices to exchange data in very close proximity. NFC is based on Radio Frequency Identification (RFID) standards including ISO/IEC 14443, ISO/IEC 18092 and Felicity Card (FeliCa). NFC standards are governed by the NFC Forum founded by Nokia, Philips and Sony in 2004 and the Forum now has over 160 members worldwide. The NFC Forum is commissioned to promote the NFC standards and certify devices for NFC compliance worldwide.

NFC allows two-way communication between NFC devices. In addition, an unpowered NFC chip (“tag”) can also be read by NFC devices, thereby enabling one-way communication as well.

NFC devices are usually used in mobile payment systems. For example, Google Wallet is a payment service and an Android app by Google to allow users to store credit card, debit card and store loyalty data on a virtual wallet—e.g., as an app downloadable to an NFC-enabled Android Smartphone—so that the user can simply tap the Android Smartphone at an NFC-enabled payment terminal to complete a sales transaction. The user can also bring his NFC-enabled Smartphone to very close proximity of an NFC-enabled payment terminal to complete the payment as well.

NFC technology is ideal for mobile payment due to its security features (matching encrypted security code and transporting access key) and extremely short transmission range (approximately 4 cm to 20 cm maximum).

At the point of sale, NFC-enabled payment terminals in the market include “PayPass” from MasterCard. MasterCard PayPass is a Europay, MasterCard and Visa (EMV) compatible, “mobile” payment feature based on the ISO/IEC 14443 standard that provides users with a simpler way to pay by tapping an NFC-enabled payment device such as an NFC-enabled Smartphone, on a point-of-sale payment terminal reader rather than swiping or inserting a card. There are an estimated 300,000 PayPass payment terminals deployed.

In September 2007, Visa introduced Visa PayWave, also a mobile payment technology feature that allows cardholders to wave their card in front of mobile payment terminals without the need to physically swipe or insert the card into a point-of-sale device. This is similar to the MasterCard PayPass service, with both using NFC or RFID technology.

In addition to Google Wallet, Verizon also offers, in partnership with AT&T and T-Mobile, a similar service called ISIS.

Known mobile payment systems require the availability of an NFC-enabled payment terminal at the point of sale. Such payment terminals are generally located at checkout areas in retail stores and are deployed in fixed locations. Users must physically bring an NFC-enabled payment device, such as an NFC-enabled Smartphone, to very close proximity of an NFC payment terminal or physically tap an NFC-enabled Smartphone on an NFC payment terminal in order to complete the transaction.

However, there are many situations where it may not be convenient for the user to bring an NFC-enabled Smartphone to an NFC-enabled payment terminal at a retail store. For example, when a user is driving a car and wishes to make payment from the NFC-enabled Smartphone, the user will be unable to complete such a transaction while inside a vehicle. Such needs may exist when the user, who is inside a motor vehicle, wishes to purchase with his NFC-enabled Smartphone parking, drive-in movies, bridge tolls or even food at a drive-through of a fast food restaurant. This disadvantage discourages wider adoption of the mobile payment technology.

### SUMMARY OF THE INVENTION

The present invention is directed to incorporation of mobile payment technology into a motor vehicle in order to allow a motorist (or user) to enjoy the benefits of mobile payment from the convenience of the motorist's motor vehicle. The present invention transforms a user's motor vehicle into a personal mobile payment terminal, and the user can make mobile payment from the convenience of the motor vehicle regardless of location.

The present invention can include an implementation whereby a merchant mobile payment system is provided to detect the presence of a motor vehicle of a customer, identify the identity of the customer through the motor vehicle equipped with a Mobile Payment Extension Kit (MPEK), and deliver payment information to the customer. The customer's motor vehicle equipped with a MPEK allows the customer to simply tap an NFC-enabled device, such as an NFC-enabled Smartphone, on the dashboard of the vehicle (or any other touch point so equipped inside the customer's vehicle) to instantly obtain payment information and authorize payment from the car. In addition, the customer may also receive additional information from the merchant including advertisement information on the NFC-enabled device while making payment, which can create additional revenue opportunities for the merchant.

In one aspect, provided herein is a vehicular-based mobile payment system comprising: a merchant system for sending and receiving information; a vehicle detection system connected to the merchant system; a vehicle comprising a mobile payment extension system, wherein the mobile payment extension system is adapted to communicate with the merchant system via the vehicle detection system; and a mobile device for sending and receiving information, wherein the mobile device is adapted to communicate with the mobile payment extension system of the vehicle.

In one embodiment of this aspect, the merchant system comprises a merchant server for management of sales transactions between a customer and a merchant.

In another embodiment of this aspect, the information includes one from the group consisting of sales information, parking information, parking rates, the maximum number of hours allowed to park, discounts, parking tips, a street cleaning schedule, a weather forecast, a visual itemized list of all of the merchant's products ordered by a customer, advertisements, targeted advertisements and nearby businesses.

In another embodiment of this aspect, the vehicle detection system comprises a mechanism to detect presence of a component of the vehicle comprising the mobile payment extension system and extract identifying information on an identity of a customer inside the vehicle.

In another embodiment of this aspect, the vehicle detection system communicates with the mobile payment extension system by utilizing near field communication (NFC) compliant devices.

In another embodiment of this aspect, the vehicle detection system comprises a vehicular roadway comprising an NFC chip.

In another embodiment of this aspect, the mobile payment extension system comprises a vehicle part comprising an NFC chip.

In another embodiment of this aspect, the mobile payment extension system comprises a road contact module, an extension circuitry module and a dashboard module.

In another embodiment of this aspect, the road contact module comprises a near field communication (NFC) chip.

In another embodiment of this aspect, the NFC chip comprises information about the vehicle and information about a consumer.

In another embodiment of this aspect, the extension circuitry module is electrically connected to the road contact module and the dashboard module and comprises a computer processor, a memory and software to control and manage communications between the dashboard module and the merchant system.

In another embodiment of this aspect, the dashboard module comprises a near field communication (NFC) chip adapted for communication with an NFC-enabled mobile device.

In another aspect, provided herein is a vehicular-based security system comprising: a vehicle comprising a mobile communication system and a security system operatively connected with an ignition or starter system of the vehicle; and a mobile device for sending and receiving information, wherein the mobile device is adapted to communicate with the mobile communication system of the vehicle, and the mobile communication system is adapted to communicate with the security system.

In one embodiment of this aspect, each of the mobile communication system and mobile device is adapted for near field communications (NFC).

In another embodiment of this aspect, the mobile device comprises a system for allowing a user to sign-in to the security system and unlock the vehicle ignition or starter system by engaging NFC between the mobile device and mobile communication system.

In another embodiment of this aspect, the mobile communication system comprises an NFC target and wherein the vehicle is started by tapping the mobile device to the target.

In another embodiment of this aspect, the mobile communication system comprises a system for validating a credential of the user stored on the mobile device before unlocking the vehicle ignition or starter system.

In another aspect, provided herein is a method for providing vehicular-based mobile payment comprising: connecting a vehicle detection system to a merchant system; connecting a mobile payment extension system to a vehicle; sending and receiving information between the merchant system and the vehicle via the vehicle detection system and the mobile payment extension system; and sending and receiving information via a mobile device, wherein the mobile device is adapted to communicate with the mobile payment extension system of the vehicle.

In one embodiment of this aspect, the merchant system comprises a merchant server for management of sales transactions between a customer and a merchant.

In another embodiment of this aspect, the information includes one from the group consisting of sales information, parking information, parking rates, the maximum number of hours allowed to park, discounts, parking tips, a street cleaning schedule, a weather forecast, a visual itemized list of all of the merchant's products ordered by a customer, advertisements, targeted advertisements and nearby businesses.

In another embodiment of this aspect, the vehicle detection system comprises a mechanism to detect presence of a component of the vehicle comprising the mobile payment extension system and extract identifying information on an identity of a customer inside the vehicle.

In another embodiment of this aspect, the vehicle detection system communicates with the mobile payment extension system by utilizing near field communication (NFC) compliant devices.

In another embodiment of this aspect, the vehicle detection system comprises a vehicular roadway comprising an NFC chip.

In another embodiment of this aspect, the mobile payment extension system comprises a vehicle part comprising an NFC chip.

In another embodiment of this aspect, the mobile payment extension system comprises a road contact module, an extension circuitry module and a dashboard module.

In another embodiment of this aspect, the road contact module comprises a near field communication (NFC) chip.

In another embodiment of this aspect, the NFC chip comprises information about the vehicle and information about a consumer.

In another embodiment of this aspect, the extension circuitry module is electrically connected to the road contact module and the dashboard module and comprises a computer processor, a memory and software to control and manage communications between the dashboard module and the merchant system.

In another embodiment of this aspect, the dashboard module comprises a near field communication (NFC) chip adapted for communication with an NFC-enabled mobile device.

In another aspect, provided herein is a method for providing vehicular-based security comprising: providing a vehicle with a mobile communication system and a security system operatively connected with an ignition or starter system of the vehicle; and providing a mobile device for sending and receiving information, wherein the mobile device is adapted to communicate with the mobile communication system of the vehicle, and the mobile communication system is adapted to communicate with the security system.

In one embodiment of this aspect, each of the mobile communication system and mobile device is adapted for near field communications (NFC).

In another embodiment of this aspect, the mobile device comprises a system for allowing a user to sign-in to the security system and unlock the vehicle ignition or starter system by engaging NFC between the mobile device and mobile communication system.

In another embodiment of this aspect, the mobile communication system comprises an NFC target and wherein the vehicle is started by tapping the mobile device to the target.

In another embodiment of this aspect, the mobile communication system comprises a system for validating a credential of the user stored on the mobile device before unlocking the vehicle ignition or starter system.

In another aspect, provided herein is a non-transitory computer-readable storage medium storing one or more programs configured to be executed by one or more processing units at a computer comprising instructions for: connecting a vehicle detection system to a merchant system; connecting a mobile payment extension system to a vehicle; sending and receiving information between the merchant system and the vehicle via the vehicle detection system and the mobile payment extension system; and sending and receiving information via a mobile device, wherein the mobile device is adapted to communicate with the mobile payment extension system of the vehicle.

In another aspect, provided herein is a user interface for a vehicular-based mobile payment system, the vehicular-based mobile payment system comprising: a merchant system for sending and receiving information; a vehicle detection system connected to the merchant system; a vehicle comprising a mobile payment extension system, wherein the mobile payment extension system is adapted to communicate with the merchant system via the vehicle detection system; and a mobile device for sending and receiving information, wherein the mobile device is adapted to communicate with the mobile payment extension system of the vehicle, wherein a user communicates with the mobile device via the user interface displayed on the mobile device.

In one embodiment of this aspect, the user interface communicates with the mobile payment extension system, which controls information displayed on the user interface.

In another embodiment of this aspect, the user interface comprises a system for managing security settings.

In another embodiment of this aspect, the user interface comprises a system for enabling and disabling mobile payment capability.

In another embodiment of this aspect, the user interface comprises a system for managing advertising messages.

In another embodiment of this aspect, the user interface comprises a system for managing user profile settings.

In another embodiment of this aspect, the user interface comprises a system to support multiple users.

In another embodiment of this aspect, the system to support multiple users comprises a means for personalizing temperature inside the vehicle, a means for personalizing settings of audio equipment, a means for personalizing seat adjustment and positioning, and a means for personalizing a position of a mirror attached to the vehicle.

In another embodiment of this aspect, the extension circuitry module comprises a security system operatively connected with an ignition or starter system of the vehicle.

In another embodiment of this aspect, the user interface comprises a system for exchanging information between a merchant and a user of the user interface.

In another embodiment of this aspect, the system for exchanging information comprises a TCP/IP communication protocol.

In another embodiment of this aspect, the system for exchanging information comprises a session initiation protocol (SIP).

In another embodiment of this aspect, the system for exchanging information allows the user to block or filter specified types of information from the merchant.

In another embodiment of this aspect, the system for exchanging information is adapted to transmit promotional messages from the merchant to the user.

In another embodiment of this aspect, the system for exchanging information is adapted to prompt a user to select a product or service offered by the merchant.

In another embodiment of this aspect, the system for exchanging information is adapted to transmit the user's selections of a product or service to the merchant system, to calculate a total payment due to the merchant, to transmit a payment notice to the mobile device via the dashboard module.

In another embodiment of this aspect, the system for exchanging information is adapted to transmit targeted information based on information stored in the extension circuitry module.

In another embodiment of this aspect, the information stored in the extension circuitry module comprises at least one of a model of the user's vehicle, a make of the user's vehicle, an age of the user's vehicle, the user's selections of the product or service, a location of the merchant, a date, a time, traffic related information relating to the merchant's location and community or public service messages based on the merchant's location.

In another embodiment of this aspect, the targeted information comprises an electronic coupon.

In another embodiment of this aspect, the user interface comprises a system for delivering ad hoc real-time voice communications between a merchant and the user.

In another embodiment of this aspect, communication protocols between the mobile device and the merchant server are based on the protocols of SIP.

In another embodiment of this aspect, communication protocols between the mobile device and the merchant server are based on the protocols of TCP/IP.

In another embodiment of this aspect, the mobile device and the merchant server are engaged in voice-over-IP communications.

In another embodiment of this aspect, an SIP User Agent (UA) software module is incorporated into the mobile device and the merchant server.

In another embodiment of this aspect, the user interface comprises a system for delivering ad hoc real-time video communications between a merchant and the user.

In another embodiment of this aspect, the user interface comprises a system for delivering ad hoc real-time live chat or instant messaging communications between a merchant and the user.

In another embodiment of this aspect, the user is prompted to remit payment for goods or services from the merchant before the goods are provided or before the services are rendered.

In another embodiment of this aspect, the user is prompted to remit payment for goods or services from the merchant after the goods are provided or after the services are rendered.

In another embodiment of this aspect, the merchant server starts a timer to time the duration of a service, and wherein the user stops the timer by tapping the mobile device to a device inside the user's vehicle that is in communication with the merchant server so as to notify the merchant server of the user's return.

In another embodiment of this aspect, the service is a parking service.

In another embodiment of this aspect, payment is made between a merchant and a user by an action of the user.

In another embodiment of this aspect, final payment authorization is performed when the user taps the mobile device on to a device inside the user's vehicle or places the mobile device in close proximity to the device inside the user's vehicle.

In another embodiment of this aspect, the user interface comprises a means for filtering unwanted advertising messages.

In another embodiment of this aspect, the user interface comprises a screen layout, a menu bar and icon placement, and wherein the screen layout, the menu bar, and the icon placement are determined by a user's settings and/or by services or products offered by the merchant.

In another aspect, provided herein is a method for vehicular-based mobile payment, the method comprising: sending and receiving information via a merchant system; connecting a vehicle detection system to the merchant system; connecting a mobile payment extension system to a vehicle, wherein the mobile payment extension system is adapted to communicate with the merchant system via the vehicle detection system; sending and receiving information via a mobile device, wherein the mobile device is adapted to communicate with the mobile payment extension system of the vehicle; providing a user interface on the mobile device; and displaying information to the user via the user interface.

In one embodiment of this aspect, the user interface communicates with the mobile payment extension system, which controls information displayed on the user interface.

In another embodiment of this aspect, the user interface comprises a system for managing security settings.

In another embodiment of this aspect, the user interface comprises a system for enabling and disabling mobile payment capability.

In another embodiment of this aspect, the user interface comprises a system for managing advertising messages.

In another embodiment of this aspect, the user interface comprises a system for managing user profile settings.

In another embodiment of this aspect, the user interface comprises a system to support multiple users.

In another embodiment of this aspect, the system to support multiple users comprises a means for personalizing temperature inside the vehicle, a means for personalizing settings of audio equipment, a means for personalizing seat adjustment and positioning, and a means for personalizing a position of a mirror attached to the vehicle.

In another embodiment of this aspect, the mobile payment extension system comprises a security system operatively connected with an ignition or starter system of the vehicle.

In another embodiment of this aspect, the user interface comprises a system for exchanging information between a merchant and a user of the user interface.

In another embodiment of this aspect, the system for exchanging information comprises a TCP/IP communication protocol.

In another embodiment of this aspect, the system for exchanging information comprises a session initiation protocol (SIP).

In another embodiment of this aspect, the system for exchanging information allows the user to block or filter specified types of information from the merchant.

In another embodiment of this aspect, the system for exchanging information is adapted to transmit promotional messages from the merchant to the user.

In another embodiment of this aspect, the system for exchanging information is adapted to prompt a user to select a product or service offered by the merchant.

In another embodiment of this aspect, the system for exchanging information is adapted to transmit the user's selections of a product or service to the merchant system, to calculate a total payment due to the merchant, to transmit a payment notice to the mobile device via the dashboard module.

In another embodiment of this aspect, the system for exchanging information is adapted to transmit targeted information based on information stored in the extension circuitry module.

In another embodiment of this aspect, the information stored in the extension circuitry module comprises at least one of a model of the user's vehicle, a make of the user's vehicle, an age of the user's vehicle, the user's selections of the product or service, a location of the merchant, a date, a time, traffic related information relating to the merchant's location and community or public service messages based on the merchant's location.

In another embodiment of this aspect, the targeted information comprises an electronic coupon.

In another embodiment of this aspect, the user interface comprises a system for delivering ad hoc real-time voice communications between a merchant and the user.

In another embodiment of this aspect, communication protocols between the mobile device and the merchant server are based on the protocols of SIP.

In another embodiment of this aspect, communication protocols between the mobile device and the merchant server are based on the protocols of TCP/IP.

In another embodiment of this aspect, the mobile device and the merchant server are engaged in voice-over-IP communications.

In another embodiment of this aspect, an SIP User Agent (UA) software module is incorporated into the mobile device and the merchant server.

In another embodiment of this aspect, the user interface comprises a system for delivering ad hoc real-time video communications between a merchant and the user.

In another embodiment of this aspect, the user interface comprises a system for delivering ad hoc real-time live chat or instant messaging communications between a merchant and the user.

In another embodiment of this aspect, the user is prompted to remit payment for goods or services from the merchant before the goods are provided or before the services are rendered.

In another embodiment of this aspect, the user is prompted to remit payment for goods or services from the merchant after the goods are provided or after the services are rendered.

In another embodiment of this aspect, the merchant server starts a timer to time the duration of a service, and wherein the user stops the timer by tapping the mobile device to a device inside the user's vehicle that is in communication with the merchant server so as to notify the merchant server of the user's return.

In another embodiment of this aspect, the service is a parking service.

In another embodiment of this aspect, payment is made between a merchant and a user by an action of the user.

In another embodiment of this aspect, final payment authorization is performed when the user taps the mobile device on to a device inside the user's vehicle or places the mobile device in close proximity to the device inside the user's vehicle.

In another aspect, provided herein is a non-transitory computer-readable storage medium storing one or more programs configured to be executed by one or more processing units at a computer comprising instructions for: sending and receiving information via a merchant system; sending and receiving information between a vehicle detection system and the merchant system; sending and receiving information between a mobile payment extension system and a vehicle, wherein the mobile payment extension system is adapted to communicate with the merchant system via the vehicle detection system; sending and receiving information via a mobile device, wherein the mobile device is adapted to communicate with the mobile payment extension system of the vehicle; providing a user interface on the mobile device; and displaying information to the user via the user interface.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted based on the text of the specification and the spirit and scope of the teachings herein.

In the drawings, where like reference numerals refer to like reference in the specification:

FIG. 1 depicts an embodiment for a merchant to deploy Merchant Road Detection Circuitry embedded on a surface of a road or a parking lot;

FIG. 2 illustrates one embodiment of a Mobile Payment Extension Kit;

FIG. 3 illustrates an example of a communication path between the Merchant Server, Merchant Road Detection Circuitry, Road Contact Module, Extension Circuitry Module, Dashboard Module and user's NFC-enabled payment device such as an NFC-enabled Smartphone;

FIG. 3A illustrates an example implementation of VoIP communication between the user's NFC-enabled Smartphone and a Merchant Server using SIP technology;

FIG. 4 shows a flow chart of execution of software inside the Extension Circuitry Module;

FIG. 5 is a flow chart of an algorithm of the Merchant Server;

FIG. 6 depicts an example of the Road Contact Module provided so as to proportionally protrude into a space between an edge of a wheel and a tire;

FIG. 7 depicts an example of a valve-mounted Road Contact Module; and

FIG. 8 depicts an example of a band-mounted Road Contact Module.

### DETAILED DESCRIPTION

It should be understood that this invention is not limited to the particular methodology, protocols, etc., described herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities used herein should be understood as modified in all instances by the term “about.”

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

### SOME SELECTED DEFINITIONS

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean±1%.

The singular terms “a,” “an,” and “the” include plural referents unless context clearly indicates otherwise. Similarly, the word “or” is intended to include “and” unless the context clearly indicates otherwise. Thus for example, references to “the method” includes one or more methods, and/or steps of the type described herein and/or which will become apparent to those persons skilled in the art upon reading this disclosure and so forth.

Although methods and materials similar or equivalent to those described herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

Vehicle Detection

A first communicant, e.g., a merchant, is provided a mechanism to detect the presence of the vehicle of a second communicant, e.g., a paying customer, and extract identifying information on the identity of the customer, for example, from an information processing system, which can be provided in the customer's vehicle or a customer's mobile communication device. In one embodiment, one or multiple grooves are cut on the pavement (such as in a merchant's parking lot or curb side of a street) and Merchant Road Detection Circuitry is embedded in the surface of the pavement. Although any suitable short-range wireless technology may be used, in one embodiment, NFC technology can be employed. In addition, the Merchant Road Detection Circuitry may include any suitable vehicle sensor system including, for example, inductive-loop detectors, magnetometers and the like.

Even though some embodiments of the present invention utilize NFC technology due to its nature of extremely short-range and secure communication, this invention is by no means limited to the use of NFC. Other forms of short-range communication include, for example, dedicated short-range communication (DSRC), IEEE 802.11, Wi-Fi, Bluetooth, RFID and the like.

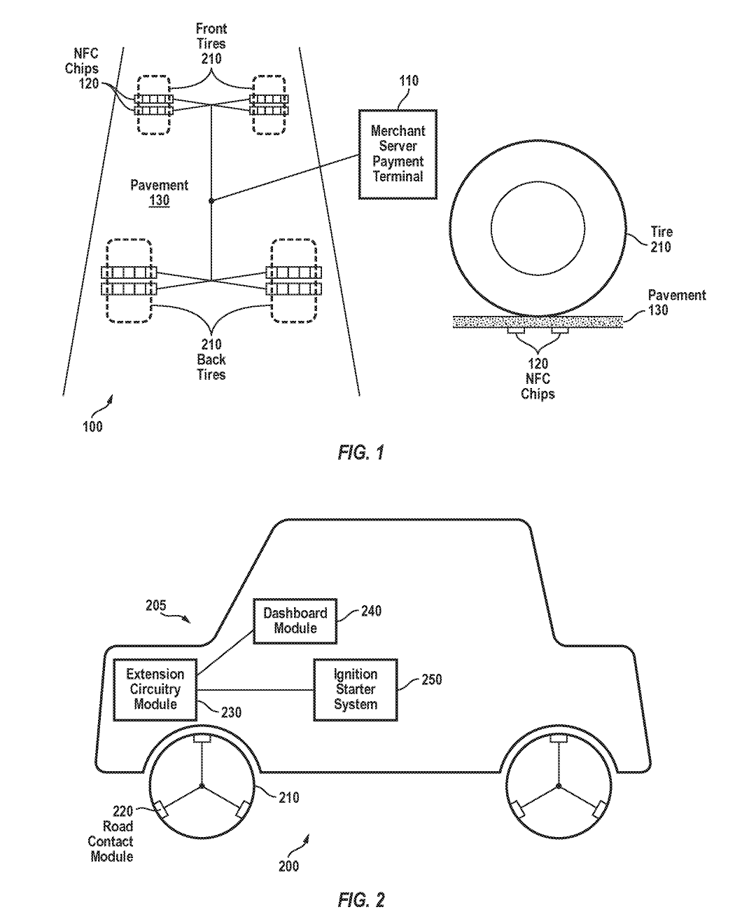

In one embodiment, Merchant NFC Road Detection Circuitry 100 is connected to the central server of the merchant (Merchant Server 110) where sales transactions are managed. FIG. 1 depicts an embodiment for a merchant to deploy Merchant Road Detection Circuitry 100 embedded on the surface of a road or a parking lot 130. In FIG. 1, two NFC chips 120 are deployed to detect one tire 210 of a motor vehicle 200 (see FIG. 2) as an illustration. All four tires 210 of a motor vehicle 200 can be detected as depicted in FIG. 1; however, just one successful detection by any one NFC chip 120 from the NFC Road Detection Circuitry 100 for any one tire would be sufficient for the purpose of completing vehicle identification.

The Merchant Road Detection Circuitry 100 may contain one or more NFC chips 120 capable of detecting an incoming NFC device, such as another NFC chip mounted on the tire 210, rim or body of an approaching vehicle 200. The actual placement of the NFC chip(s) 120 in the Merchant Road Detection Circuitry 100 and the distance between each NFC chip can vary depending on factors such as the size of the road (or parking lot), speed of approaching vehicles, the types of motor vehicles anticipated and environmental factors. A variety of geometric placements (e.g., linear stripes, circular patterns, etc.) of NFC chips 120 on a Merchant Road Detection Circuitry 100 may be possible. The NFC technology allows detection of one NFC device from another NFC device within 100 msec.

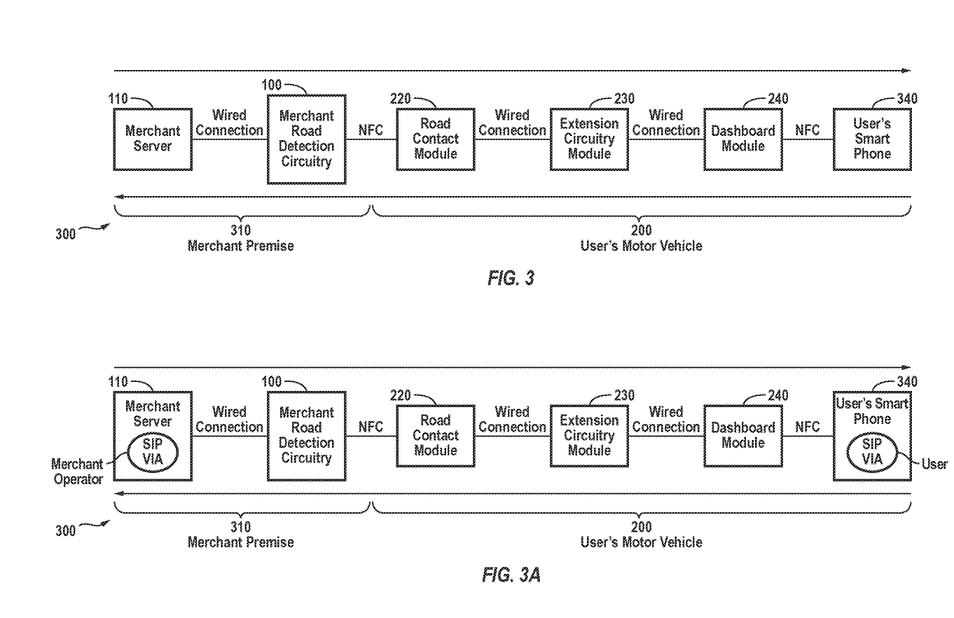

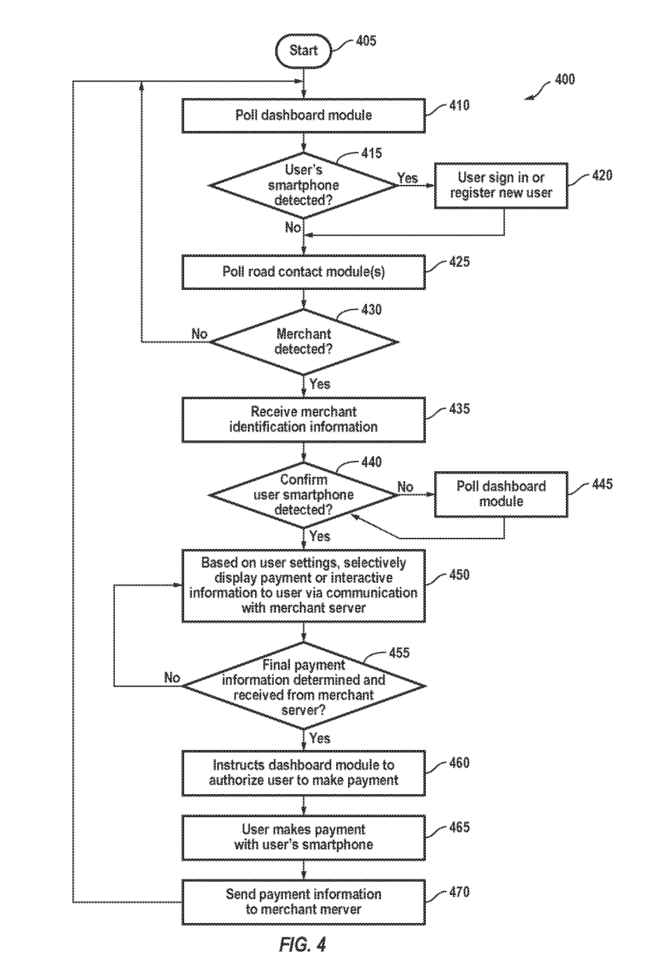

When Merchant Road Detection Circuitry 100 positively detects the presence of a motor vehicle 200, the Circuitry 100, through its onboard NFC chip 120, communicates with the NFC chip mounted on the motor vehicle 200 to establish two-way communication using established NFC communication protocols. The identity of the motor vehicle 200, encoded in the NFC chip mounted on the motor vehicle 200, can be communicated to the Merchant Server 110. The identity of the merchant, encoded in the NFC chips on the Merchant Road Detection Circuitry 100, can be communicated to the customer's motor vehicle 200 and eventually to the customer's NFC-enabled Smartphone 340 (see FIG. 3 or 3A).

The purpose of the Merchant Road Detection Circuitry is to ensure an active NFC connection between a Road Contact Module in at least one tire of a customer's vehicle and the Merchant server when the customer's vehicle is parked in a designated parking spot of the merchant. As such, the Merchant Road Detection Circuitry can take on a large variety of geometric shapes and areas (linear, circular, etc.) and redundancies in order to ensure fast and reliable contact between the customer's vehicle and the merchant server where sales transactions are to be made. Due to the low cost of the NFC chips, a relatively large surface area containing a large array of NFC chips may be financially feasible for deployment as part of the Merchant Road Detection Circuitry installation. This invention does not favor or rely on any particular layout of the Merchant Road Detection Circuitry.

The NFC chips in a Merchant Road Detection Circuitry may be encapsulated in hard plastic casings and mounted on the surface of the pavement of the merchant's parking lot. Because NFC is based on radio frequency (RF) technology which is capable of penetrating plastics, concrete materials, etc. and can operate in a variety of outdoor environments, the physical implementation of the Merchant Road Detection Circuitry may take on a variety of form factors to embed NFC chips into the surface of the pavement. This invention does not favor or rely on any particular implementation of the Merchant Road Detection Circuitry.

Road Contact Module Mounting and Installation

Each Road Contact Module can contain one or more NFC chips and may be encapsulated in a plastic casing of a variety of shapes for ease of handling. A Road Contact Module can be installed either in the stem valve of a tire or mounted on the rim of the wheel. The installation procedure can be similar to the standard installation procedure of a sensor in a Tire Pressure Monitoring System (TPMS).

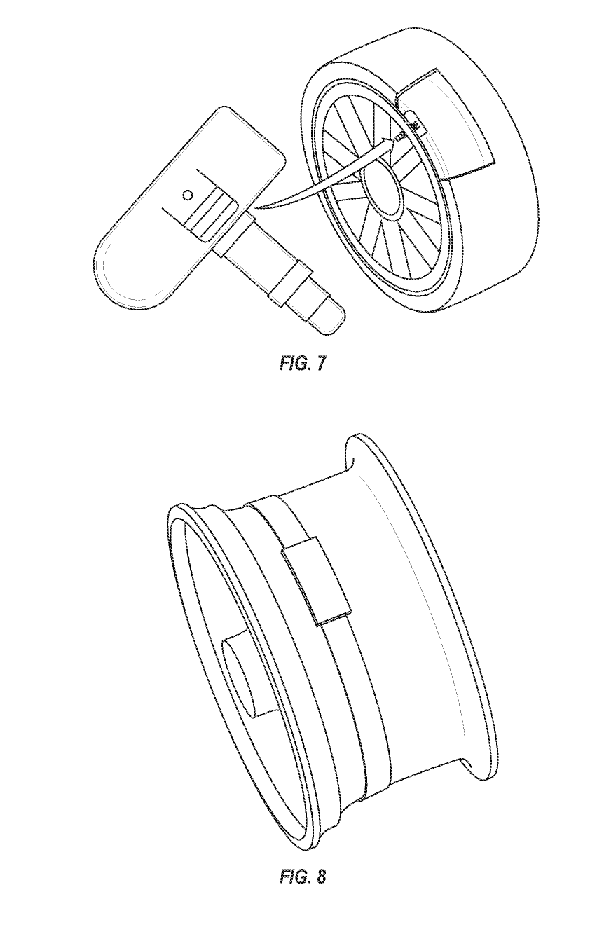

FIGS. 7 and 8 illustrate examples of installation processes for application of a device such as a Road Contact Module to a rim or tire of a vehicle. FIG. 7 depicts an example of a valve-mounted device, which may be a sensor, an NFC chip, circuitry, housings, support modules or a Road Contact Module. FIG. 8 depicts an example of a band-mounted device. FIG. 7 depicts a design where the installation of a Road Contact Module is on the stem valve of the tire. The advantage of this design is ease of installation as the tire does not have to be dismounted from the wheel to perform the installation. The disadvantage of this design is that there can only be one Road Contact Module for each tire, hence increasing the likelihood of the Road Contact Module on the tire not making contact with the Merchant Road Detection Circuitry. FIG. 8 depicts another design where a Road Contact Module is mounted through a band onto the wheel of the vehicle. The disadvantage of this design is the necessity of having to remove the tire from the wheel before installation can take place. The advantage of this design is that multiple Road Contact Modules can be mounted along the entire circumference of the wheel.

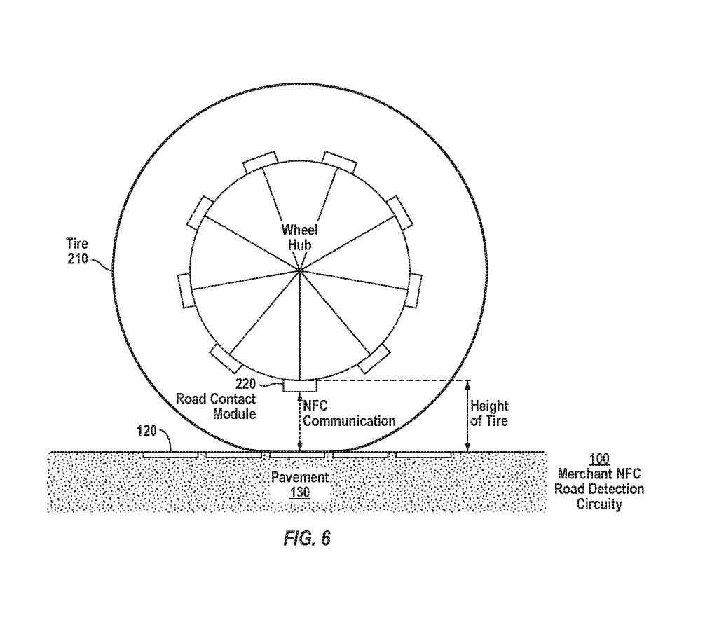

For the purpose of this invention, the design depicted in FIG. 8 is preferred because it allows a greater number of Road Contact Modules to be mounted along the perimeter of the wheel to ensure contact with at least one NFC chip embedded in the Merchant Road Detection Circuitry. Further, the Road Contact Module is physically designed to proportionally protrude more into the space between the edge of the wheel and the tire (depending on the height of the tire) so as to ensure the distance between the NFC chip in the Road Contact Module and the NFC chip in the Merchant Road Detection Circuitry meet the distance range limitation required by the NFC protocol. See FIG. 6 for an illustration. The actual implementation such as the number of Road Contact Modules required on the circumference of a wheel, the physical placement of each Road Contact Module along the circumference of the wheel and the placement of NFC chips in the Merchant Road Detection Circuitry on a pavement will vary depending on the vehicle tire size, vehicle wheel size, number of tires to be equipped with the Road Contact Modules, length and size of the parking stall on merchant premises and other environmental conditions. The system is designed to ensure the vehicle is in full NFC contact with the merchant server when in a parked position. Additionally, the merchant can deploy parking lot markings or grooves or bumps to help guide the vehicle to properly position itself to be in full NFC contact. Furthermore, an audible signal or a visual signal could be deployed at the merchant's premises to inform the driver of the vehicle that his vehicle is locked in position for NFC communication with the merchant.

Wireless vs. Wireline Connection Between Road Contact Modules and Extension Circuitry Module

The connection between a Road Contact Module and the Extension Circuitry Module could be either wireline or wireless (via NFC, a type of RF signal such as Bluetooth and the like). Further, utilizing a wireless connection technology such as NFC or Bluetooth between a Road Contact Module and the Extension Circuitry Module could simplify installation because there would not be any wiring to deal with. The disadvantage of a wireless connection is that the Road Contact Module would need to run on a battery, which would require replacement at a certain point of time depending on the life of the battery used to power the Road Contact Module. Furthermore, secure wireless connections are desirable. The wireless system is designed to avoid falsely detecting the Road Contact Module of a neighboring car, for example, by utilizing encryption or coding of signals.

In one embodiment, a wireline connection is utilized between multiple Road Contact Modules and the Extension Circuitry Module. Specifically, a rotating mechanical swivel hub can be deployed and mounted in the center of the wheel. See FIG. 6. Such a mechanical hub is physically attached to the wheel and spins with the wheel with the center of the hub always in a fixed position which is also the center of the wheel. Physical wiring electrically connects each Road Contact Module with the hub in the center of the wheel. Such wiring is also physically attached to the wheel and rotates with the wheel. The swivel hub maintains an electrical connection to the Extension Circuitry Module which is mounted elsewhere in the vehicle. (The exact location of the Extension Circuitry Module and installation procedure varies from car to car.) Hence each Road Contact Module is electrically connected, via a wireline connection through the hub, to the Extension Circuitry Module. It should be noted that there are numerous other electromechanical methods to connect via wireline a set of rotating Road Contact Modules with the Extension Circuitry Module.

MPEK

The Mobile Payment Extension Kit (MPEK) is a modular hardware kit which can be installed professionally on a motor vehicle to equip such vehicle with mobile payment capability. FIG. 2 illustrates one embodiment of a MPEK 205. A MPEK 205 can contain three modules: one or more Road Contact Module(s) 220, an Extension Circuitry Model 230 and a Dashboard Module 240.

The technologies in the MPEK are intended to be either directly manufactured in the vehicle by the car manufacturers or the MPEK can be a kit for installation by a professional installer or end users for after-market applications.

Road Contact Module

In one embodiment, a MPEK 205 contains one or more NFC chips encapsulated in one or more Road Contact Modules 220 which can be mounted on the tire(s) 210 of a motor vehicle 200. Depending on the size of the tires 210 and types of vehicles, multiple Road Contact Modules 220 may be mounted in multiple positions on one or more tires 210 to ensure fast and efficient detection of the identity of the vehicle by the Merchant Road Detection Circuitry 100 installed by the merchant. The Road Contact Modules 220 can be mounted on the inside or outside of a tire 210 depending on the configuration of the tire and how the tire is installed in the vehicle. The NFC chip(s) on a Road Contact Module 220 may be pre-programmed with the identity of the motor vehicle (such as the Vehicle Identification Number), model and make of the car and information about its owner so as to facilitate automatic detection of the owner's credentials by the merchant. NFC chips today are commercially available for under $3 each and, with mass manufacturing, the cost of the NFC chips can be significantly reduced to allow the Road Contact Module 220 to be manufactured and made affordable to average consumers.

Extension Circuitry Module

In one embodiment, the Extension Circuitry Module 230 is the electrical circuit inside a motor vehicle 200 to electrically connect one or more Road Contact Modules 220 from the tire(s) 210 of a motor vehicle 200 to the Dashboard Module 240 mounted on the dashboard of a motor vehicle 200. The Extension Circuitry Module 230, powered by the battery of the motor vehicle 200, provides power to the Road Contact Module(s) 220 and Dashboard Module 240 and hosts a computer processor, memory and software to control and manage the communications between the user inside his vehicle and the merchant.

FIG. 3 illustrates an example of the communication path 300 between the Merchant Road Detection Circuitry 100, Road Contact Module 220, Extension Circuitry Module 230, Dashboard Module 240 and user's NFC-enabled payment device such as an NFC-enabled Smartphone 340. In one embodiment, the Merchant Server 110 can have a wired connection with the Merchant Road Detection Circuitry 100, which can have an NFC connection with the Road Contact Module 220, which can have a wired connection with the Extension Circuitry Module 230, which can have a wired connection with the Dashboard Module 240, which can have an NFC connection with the NFC-enabled Device 340. The Merchant Server 110 and the Merchant Road Detection Circuitry can be provided as part of the merchant premises 310, and the Road Contact Module 220, Extension Circuitry Module 230 and Dashboard Module 240 can be provided as part of the user's Motor Vehicle 200, and can have wireless connections between the various Modules. The Dashboard Module 240 can communicate with the NFC-enabled Device 340 via NFC connection. Communication may originate at the Merchant Server 110 and progress through the Circuitry 100, Modules 220, 230 and 240 to the NFC-enabled Device 340, and vice-versa, i.e., communication may originate at the NFC-enabled Device 340 and progress through the Modules 240, 230 and 220 and the Circuitry 100 to the Merchant Server 110.

FIG. 4 shows a flow chart of the execution of the software inside the Extension Circuitry Module 230. Specifically, an Extension Circuitry Module Algorithm 400 includes the following steps, which may be preformed in any suitable order:
Start 405
Poll Dashboard Module 410
Query whether a User's Smartphone is detected 415
   If yes, then a User signs in or registers as a new user 420, and progresses to the next step
   If no, then go to the next step
Poll Road Contact Module(s) 425
Query whether a Merchant is detected 430
   If yes, then go to the next step
   If no, then the process returns to Step 410
Receive Merchant Identification Information 435
Confirm whether a user's Smartphone is detected 440
   If yes, then go to the next step
   If no, then Poll Dashboard Module 445 until the user's Smartphone is detected
Based on user settings, selectively display payment or interactive information to the user via communication with the Merchant Server 450
Query as to whether final payment information determined and received from the Merchant Server 455
   If yes, then go to the next step
   If no, then go to Step 450
Instruct Dashboard Module to authorize user to make payment 460
User makes payment with user's Smartphone 465
Send payment information to Merchant Server 470
Return to Step 410

In essence, the Extension Circuitry Module 230 acts as the brain of the vehicular-based mobile payment system and its function is to facilitate payment and other data communications between the user inside the vehicle and the merchant. The Extension Circuitry Module 230 may also be connected wirelessly to the Road Contact Module(s) 220 using an appropriate Radio Frequency (RF) technology in order to facilitate installation. However a wired connection between the Extension Circuitry Module 230 and Road Contact Module(s) 220 may be more secure for the purpose of processing payment information.

Dashboard Module

The Dashboard Module 240 contains one NFC chip and is typically mounted on the dashboard, steering wheel or instrument panel of a motor vehicle 200. The Dashboard Module 240 is the physical interface for the user to tap into the merchant's payment system. When a motor vehicle 200 is parked at a merchant's location equipped with Merchant Road Detection Circuitry 100, and the communication between the Dashboard Module 240 and Merchant's payment system is established by the Extension Circuitry Module 230, the user can simply tap an NFC-enabled Smartphone 340 enabled with mobile payment technology (for example, technologies comparable to the Google Wallet and the Google Wallet app) on the Dashboard Module 240 and instantly receive payment information on the item to be purchased from the merchant.

Payment and Additional Information Delivery

Once the communication between the Merchant Server 110 and the user's NFC-enabled Smartphone 340 is established, the merchant can send additional information to the user in addition to payment information. In one embodiment, a user may receive on his NFC-enabled Smartphone 340 parking information and rates from the merchant from the convenience of the inside of a car as soon as the car is parked. The parking information may contain helpful information such as the maximum number of hours allowed to park, parking rates, discounts, parking tips (such as tilting tires inward when parking downhill), street cleaning schedule, today's weather forecast, etc. Also, the user may be prompted to enter on his NFC-enabled Smartphone 340 how long to park so that the Merchant Server 110 can determine the actual payment amount. As another example, a user may receive a visual itemized list of all of the foods he just ordered at the drive-through of a fast food restaurant and be presented with a final bill to pay. Furthermore, the user may also receive from the merchant other non-payment related information from the merchant and approved advertisers. All advertisement and messages from the merchant are managed and sent by the merchant from the Merchant Server 110.

Personal Settings

Personal settings related to the Vehicular-based Mobile Payment System for a particular user can be set and changed via a user interface presented by the Dashboard Module 240 on the screen of the user's NFC-enabled Smartphone 340 and are completely configurable from inside a car. In one embodiment, Personal Settings function is rendered to the user on the user's NFC-enabled Smartphone 340 via an app developed in iOS, Android or other mobile operating system. This app communicates with the Extension Circuitry Module 230 and renders the appropriate user interface on the user's NFC-enabled Smartphone 340 under the control of the Extension Circuitry Module 230. Settings can include security settings, enabling or disabling mobile payment capability, filtering unwanted advertisement messages from the merchant, etc. All settings are stored in the memory of the Extension Circuitry Module 230 and can be changed by the user at any time from his Smartphone regardless of the presence of any Merchant Road Detection Circuitry 100. Settings can be unique to a particular user and not shared with other users who could share the same vehicle. The Extension Circuitry Module 230 can store the profiles and settings of multiple users (drivers) and only enable the settings/profile of the user who signs in to the System with his NFC-enabled Smartphone 340. Sign-in can be simply accomplished by a user tapping his NFC-enabled Smartphone 340 on the Dashboard Module 240. When a first-time user attempts to use the System, the Extension Circuitry Module 230 will identify this condition by detecting the identification information contained in the NFC chip of the user's NFC-enabled Smartphone 340 and prompts the user to enter a series of settings questions in order to set up the settings/profile of the new user. Once the settings/profile of a new user is set up, the new user is created and the user's settings are stored in the memory of the Extension Circuitry Module 230. Further, the user's profile settings can store additional user personal data such as preferred temperature in the car, personalized audio system settings including radio button settings, personalized seat positioning, personalized mirror settings and the like. The additional personal settings can be stored in the vehicle's Extension Circuitry Module 230, which can be electrically connected to the car's computer system to instruct the car's computer system to effect the requested changes.

Security Feature

The Extension Circuitry Module 230 can further act as a car security device to prevent drivers with unauthorized sign-in credentials from starting the vehicle. Authorized users can simply sign-in and unlock the vehicle by tapping his NFC-enabled Smartphone 340 on the Dashboard Module 240. The software in the Extension Circuitry Module 230 validates the credentials of a driver via his NFC-enabled Smartphone 340 and authorizes the vehicle to start only if the credentials are validated. The Extension Circuitry Module 230 may be electrically connected to the vehicle's ignition system 250 to perform this security function. This security feature can be made to be independent from the mobile payment system of this invention.

User Interactivity

This invention transforms a traditional mobile payment technology usable only at a fixed point of sale location into an interactive tool between the merchant and a user from the convenience of the user's vehicle at any location. The merchant will have more opportunities to present information to the user in addition to just prompting the user for payment as is the case in traditional mobile payment technology. Through the easy-to-use user interface of a Smartphone, the user will have ample opportunities to react to the messages brought to him by the merchant in addition to paying the merchant. The merchant may take advantage of this opportunity to further engage the user and provide better customer service.

User interactivity is made possible by communications between the Merchant Server 110 located at the merchant premises and the Extension Circuitry Module 230 located in the user's vehicle. The Merchant Server 110 and the Extension Circuitry Module 230 together determine what types of information to deliver to the user and what kind of inputs to receive from the user. In one embodiment, a particular type of communication protocol can be defined between the Merchant Server 110 and the Extension Circuitry Module 230 to facilitate the communication between them. For example, the underlying communication protocol for the transport layer and Internet layer may be TCP/IP and the application layer protocol may be Session Initiation Protocol (SIP). This protocol allows the Merchant Server 110 and the user's Extension Circuitry Module 230 to jointly determine what types of interactivity, if any, are to be delivered to the user. Through settings defined in a user's profile, a user can limit the type of interactions with the merchant. In the simplest possible scenario, the user can choose, through his settings in the Extension Circuitry Module 230, to only receive payment information and disallow any other types of messages from the merchant such as advertisements. Hence the Extension Circuitry Module 230 serves a filtering function on behalf of the user to filter out unwanted unsolicited messages from the Merchant Server 110.

In one embodiment, User Interactivity is rendered to the user on the user's NFC-enabled Smartphone 340 via an app developed in iOS, Android or other mobile operating system. This app communicates with the Extension Circuitry Module 230 and renders the appropriate user interface on the user's Smartphone depending on the results of communication between the Extension Circuitry Module 230 and the Merchant Server 110.

In one embodiment, the user may receive promotional messages relating to multiple services or products offered by the merchant and the user can select a particular service or product to purchase to suit the user's needs from the convenience of the user's NFC-enabled Smartphone 340. For example, a user in a parking lot may be presented with the hourly rates of parking and the user may select the number of hours to park and the Merchant Server 110 will compute the total payment due and instructs the Extension Circuitry Module 230 to deliver the payment notice to the user's NFC-enabled Smartphone 340 via the Dashboard Module 240.

In one embodiment, the user may receive advertisement messages on his NFC-enabled Smartphone 340 from the merchant or the merchant's business partners. The advertisement messages may be stored on the Merchant Server 110 and software on the Merchant Server 110 is able to make intelligent decision on what types of advertisement messages to deliver to the user by the user's identification information and by the settings in the user's profile stored in the vehicle's Extension Circuitry Module 230. Such targeted advertising can be served to the user based on the following targeting criteria:

Model and make of user's motor vehicle

Age of the user's motor vehicle

Type of tires of the user's motor vehicle

Type of products or services user just ordered

Location of the merchant

Date and time of the day

Nearby traffic related messages based on the merchant location

Community or public service messages based on merchant location

In one embodiment, electronic coupons can also be optionally generated and delivered from the Merchant Server 110 to the user's NFC-enabled Smartphone 340, and the electronic coupons can be stored in an application loaded on the Smartphone 340. For example, if the merchant determines the user's vehicle is a Honda Accord, then the merchant can deliver Honda Accord related car repair or service coupons to the user's Smartphone. Interactivity can be enabled either before or after payment is made for as long as the user chooses to keep his NFC-enabled Smartphone 340 in close proximity to the Dashboard Module 240. An example of a User Interactivity after payment is made is for the merchant to conduct a customer survey directly on the user's Smartphone.

Dynamic User Interface Capability

The user interface can be determined by the user's settings and/or by the type of products or services the merchant is selling. The user interface need not necessarily be a fixed interface, and the user interface can be adapted to change depending on where the vehicle is located. For example, if the vehicle is located in a restaurant drive-through such as a McDonald's drive through, the user interface can be adapted to change to suit the needs of the restaurant drive-through, and if the vehicle is located at a parking garage, the user interface can be adapted to change to suit the needs of the parking garage. Also, a default user interface can be provided when the vehicle is not connected to a merchant server and/or when a customized user interface has not been established for a particular merchant or location.

User Interactivity—Voice Communication

In addition to transaction-based interactivity between the user (via his NFC-enabled Smartphone 340 and the Extension Circuitry Module 230) and the merchant (via the Merchant Server 110), such interactivity can be expanded to include ad hoc real-time voice communications. In one embodiment, if the communication protocols between the NFC-enabled Smartphone 340, Extension Circuitry Module 230 and the Merchant Server 110 are based on the protocols of SIP, then a SIP User Agent (UA) software module can be incorporated into the NFC-enabled Smartphone 340 (e.g., embedded in an app) and the Merchant Server 110 to enable Voice-over-IP communications between these 2 end points. Voice-over-IP (or VoIP) and SIP UA are well known in the art and will not be described here. FIG. 3A illustrates an example implementation of VoIP communication between the user's NFC-enabled Smartphone 340 and the Merchant Server 110 using the SIP technology. Those skilled in the art will appreciate there are many other possible implementations of enabling VoIP communications between the user's NFC-enabled Smartphone 340 and the Merchant Server 110. According to FIG. 3A, either the user or the merchant operator can initiate a VoIP call to the other party in order to conduct a real-time VoIP call. Either the user or the merchant operator can terminate the call at any time. Those skilled in the art will appreciate that multiple merchant operators can also be accommodated in this design via the use of one or more SIP proxy servers. Furthermore, intelligent call routing may be implemented to route a user initiated call to the first available merchant operator or the best-fit merchant operator. SIP, VoIP and call center technologies are well known in the art and will not be described here. Such real-time voice calls may be useful whenever the user desires live assistance from the merchant from the user's car. Conversely, the merchant may also place a VoIP call directly to the user's car to communicate necessary information to the user in real-time without having to know the user's phone number, thereby the user's privacy is protected.

User Interactivity—Video Communication

Similar to live voice communication described above, ad hoc live video communications may also be implemented between the user's NFC-enabled Smartphone 340 and a merchant operator. In one embodiment, SIP protocols may be used to set up, maintain and tear down a video call between the user and a merchant operator. Those skilled in the art will appreciate that multiple merchant operators can also be accommodated in this design via the use of one or more SIP proxy servers. Furthermore, intelligent call routing may be implemented to route a user initiated video call to the first available merchant operator or the best-fit merchant operator. SIP, VoIP, video calls and call center technologies are well known in the art and will not be described here. Using SIP to implement video calls is well known in the art and will not be described here. Such real-time video calls may be useful whenever the user desires live assistance or live visual aid from the merchant from the user's car. As another example, the merchant may require to see the user's face for security and authentication purposes in order to authorize a transaction. Conversely, the merchant may also place a video call directly to the user's car to communicate necessary information to the user.

User Interactivity—Instant Messaging

Similar to live voice communication described above, ad hoc live chat (or instant messaging) communications may also be implemented between the user's NFC-enabled Smartphone 340 and a merchant operator. In one embodiment, SIP protocols may be used to set up, maintain and tear down a text chat or instant messaging session between the user and a merchant operator. Using SIP to implement text chat or instant messaging sessions is well known in the art and will not be described here. Such real-time instant messaging sessions may be useful whenever the user desires live assistance from the merchant from the user's car. Conversely, the merchant may also initiate an instant messaging session directly to the user's car to communicate necessary information to the user in real time.

Pre-Pay and Post-Pay

The mechanism of this invention offers the flexibility for a user to pay for services from a merchant either before the service is rendered or after the service is rendered provided the merchant allows this flexibility. This is in contrast with traditional mobile payment technology which requires a user to pay for the services on the spot as soon as service is rendered. For example, when a user pulls his car equipped with MPEK into a parking space, the user can have the flexibility to pay for parking based on the duration of his actual stay without having to make payment upfront. In this example, the following steps are performed:
User pulls his MPEK equipped car into a parking space equipped with Merchant Road Detection Circuitry 100.
User interacts with the merchant via the User Interactivity capability (described earlier) from his NFC-enabled Smartphone 340 to determine the types of services to be purchased.
The Extension Circuitry Module 230, with the user inputs accepted from User Interactivity, communicates with the Merchant Server 110 and subsequently communicates with the user whether pre-pay or post-pay is allowed.
In the event the Merchant Server 110 determines, based on the identity of the user, the Settings of the user and the type of services desired, immediate payment is required, then the Extension Circuitry Module 230 prompts the user to make payment immediately from his NFC-enabled Smartphone 340. This would be the pre-pay or pay-now scenario.
In the event the Merchant Server 110 determines payment can be made after the service is rendered, then the Extension Circuitry Module 230 notifies the user via the user's NFC-enabled Smartphone 340. For example, the merchant may require the user to pay for parking after the user returns to his car.
The user leaves the car and the Merchant Server 110 starts a timer to time the duration of the service.
The user returns to his car and taps his NFC-enabled Smartphone 340 to the Dashboard Module 240 of his car to notify the Merchant Server 110 of his return.
Through User Interactivity, the user notifies the Dashboard Module 240 to end the service (parking) from his NFC-enabled Smartphone 340.
The Dashboard Module 240 communicates with the Extension Circuitry Module 230 which in turns communicates with the Merchant Server 110 which stops the timer and determines the final payment amount due based on the duration of the user's stay.
The Merchant Server 110 communicates the final payment amount to the user's NFC-enabled Smartphone 340 via the Extension Circuitry Module 230.
The user makes payment from his NFC-enabled Smartphone 340.

The above example illustrates how a post-pay service such as parking service can be provided by this invention. Other post-pay services can be easily provided via the same mechanisms.

Payment Authorization and Confirmation

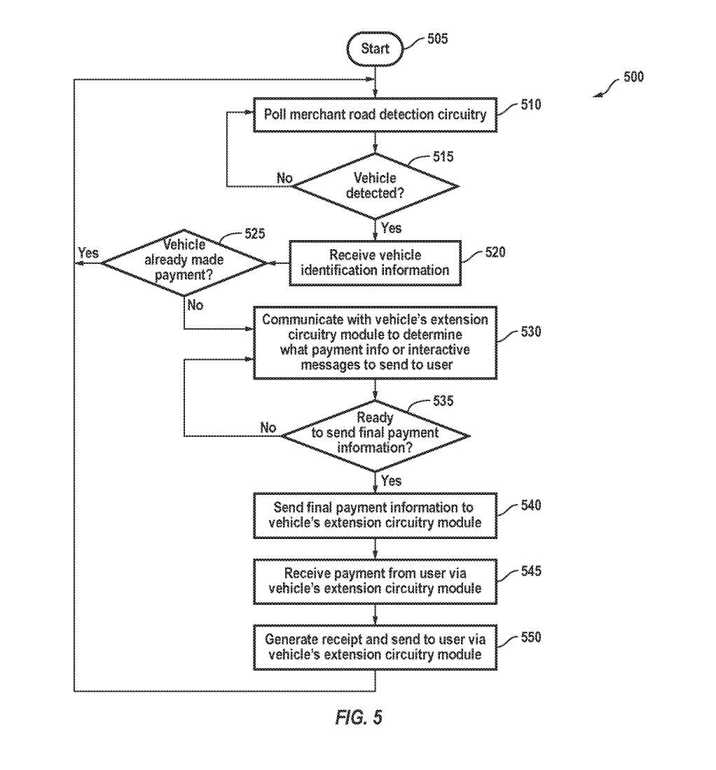

The final step in completing the sale transaction is for the user to authorize payment for the merchant's goods or services. In the simplest form and in the absence of any User Interactivity, the user can simply tap his NFC-enabled Smartphone 340 on the Dashboard Module 240 and complete the sale transaction. When User Interactivity is involved, final payment authorization can be performed by the user tapping his NFC-enabled Smartphone 340 on the Dashboard Module 240 or bringing his NFC-enabled Smartphone 340 to close proximity of the Dashboard Module 240; followed by pressing a confirmation button on the screen of the NFC-enabled Smartphone 340. The payment authorization step otherwise follows standard mobile payment transactions commercially available today. Commercially available mobile payment technology includes, for example, Google Wallet which consists of a payment service and an Android app by Google to allow users to store credit card, debit card and store loyalty data on a virtual wallet—e.g., as an app downloadable to an NFC-enabled Android Smartphone. Final payment information is sent to the payment terminal function in the Merchant Server 110 to complete the transaction. Merchant Server 110 may optionally send a receipt or confirmation to the NFC-enabled Smartphone 340 of the user via the Extension Circuitry Module 230. FIG. 5 is a flow chart of the algorithm of the Merchant Server 110. FIG. 5 outlines the steps a Merchant Server 110 performs in order to communicate with the user inside a vehicle to complete the payment process. Specifically, a Merchant Server Algorithm 500 includes the following steps, which may be preformed in any suitable order:
Start 505
Poll Merchant Road Detection Circuitry 510
Query as to whether a vehicle is detected 515
   If yes, then the proceed to the next step
   If no, then return to Step 510
Receive Vehicle Identification Information 520
Query as to whether the vehicle already made payment 525
   If yes, then return to Start 505
   If no, then go to the next step
Communicate with vehicle's extension circuitry module to determine what payment information or interactive messages to send to the user 530
Query as to whether a user is ready to send final payment information 535
   If yes, then go to the next step
   If no, then return to Step 530
Send final payment information to the vehicle's Extension Circuitry Module 540
Receive payment from user via vehicle's Extension Circuitry Module 545
Generate receipt and send to user via vehicle's Extension Circuitry Module 550

A customer client system for use with the present invention may include one or more processing units (CPU's), one or more network or other communications interfaces, memory, and one or more communication buses for interconnecting these components. The customer client system may include a user interface, for instance a display and a keyboard. The memory may include high speed random access memory and may also include non-volatile memory, such as one or more magnetic or optical storage disks. The memory may include mass storage that is remotely located from CPU's. The memory may store the following elements, or a subset or superset of such elements: an operating system that includes procedures for handling various basic system services and for performing hardware dependent tasks; a network communication module (or instructions) that is used for connecting the customer client system to other computers via the one or more communications interfaces (wired or wireless), such as the Internet, other wide area networks, local area networks, metropolitan area networks, and so on; a client application; optionally, a cache of downloaded and a cache downloaded, as well as other information for viewing using the client application, and information retrieved by user selection of one or more items.

Each of the above identified modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used herein differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

Although some of various drawings illustrate a number of logical stages in a particular order, stages which are not order dependent can be reordered and other stages can be combined or broken out. Alternative orderings and groupings, whether described above or not, can be appropriate or obvious to those of ordinary skill in the art of computer science. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to be limiting to the precise forms disclosed. Many modifications and variations are possible in view of the above teachings. The embodiments were chosen and described in order to best explain the principles of the aspects and its practical applications, to thereby enable others skilled in the art to best utilize the aspects and various embodiments with various modifications as are suited to the particular use contemplated.

1. An apparatus comprising:
a body carriage having rotatable wheels mounted thereunder, the rotatable wheels configured to roll along a surface of a pavement, each of the rotatable wheels including a tire mounted on a rim, wherein an outer surface of the rim and an inner surface of the tire define an inner space there-between;
a mobile payment extension system including:
a plurality of road contact modules mounted on the outer surface of the rim of at least one of the rotatable wheels and configured so that the plurality of road contact modules protrude away from the outer surface of the rim and into the inner space, the plurality of road contact modules configured so that at least one of the plurality of road contact modules is no more than a predetermined distance from an in-pavement vehicle detection system embedded on or below the surface of the pavement when the tire of the at least one of the rotatable wheels is positioned on the surface of the pavement, and
an extension circuitry module electrically connected to the plurality of road contact modules and comprising a computer processor, a memory, and software to control and to manage communications between the mobile payment extension system and the merchant system, and the extension circuitry module configured to receive one or more personal settings from a personal mobile communication device and configured to store the one or more personal settings; and
the mobile payment extension system configured to:
receive an input from a user of a personal mobile communication device; and
determine a screen layout for a user interface on the personal mobile communication device, the screen layout including at least a menu bar and icon placement rendered on the personal mobile communication device, the screen layout determined based on:
a user profile setting stored in the extension circuitry module of the apparatus;
a merchant type; and
a customer identity dynamically extracted from the user's personal mobile communication device;
wherein the mobile payment extension system is configured to:
control information rendered on the user interface.

2-4. (canceled)

5. The apparatus of claim 1, wherein the apparatus is further configured for exchanging customized information between a merchant and a user of the user interface.

6. The apparatus of claim 5, wherein the apparatus for exchanging customized information comprises a session initiation protocol (SIP).

7. The apparatus of claim 5, wherein the apparatus for exchanging customized information allows the user to filter specified types of information from the merchant.

8. The apparatus of claim 5, wherein the apparatus for exchanging customized information is configured to transmit promotional messages from the merchant to the user.

9. The apparatus of claim 5, wherein the apparatus for exchanging customized information is configured to prompt a user to select a product or service offered by the merchant.

10. The apparatus of claim 9, wherein the apparatus for exchanging customized information is configured to transmit the user's selections of a product or service to the merchant system, to calculate a total payment due to the merchant, to transmit a payment notice to the personal mobile communication device via a dashboard module mounted on a dashboard of the apparatus.

11. The apparatus of claim 5, wherein the apparatus for exchanging customized information is configured to transmit targeted information based on information stored in the extension circuitry module or the merchant system.

12. The apparatus of claim 11, wherein the information stored in the extension circuitry module or the merchant system comprises a model of the user's apparatus, a make of the user's apparatus, the user's selections of the product or service, a location of the merchant, a date, a time, and traffic related information relating to the merchant's location.

13. The apparatus of claim 11, wherein the targeted information comprises an electronic coupon.

14. The apparatus of claim 1, wherein the apparatus is further configured for delivering real-time voice communications between a merchant and the user while the user and the merchant are engaged in a payment transaction.

15. The apparatus of claim 14, wherein communication protocols between the personal mobile communication device and the merchant server user while the user and the merchant are engaged in a payment transaction are based on session initiation protocol (SIP).

16. The apparatus of claim 14, wherein the personal mobile communication device and the merchant are engaged in voice-over-IP (VoIP) communications while the user and the merchant are engaged in a payment transaction.

17. The apparatus of claim 1, wherein the user interface comprises a system for delivering real-time video communications between a merchant and the user while the user and the merchant are engaged in a payment transaction.

18. (canceled)

19. The apparatus of claim 1, wherein the mobile payment extension system is configured to communicate with the merchant system using near field communication (NFC).

20. The apparatus of claim 1, wherein the apparatus comprises a means for filtering advertising messages.

21. The apparatus of claim 1, wherein the user interface comprises a screen layout, a menu bar and icon placement, and wherein the screen layout, the menu bar, and the icon placement are determined by products or services offered by the merchant.

22. The apparatus of claim 1, wherein the user interface is configured to support registering multiple users, and to, based on user settings, facilitate payment communications between each of the multiple users and the merchant.

23. The apparatus of claim 1, wherein the apparatus is further configured for enabling and disabling mobile payment capability while maintaining communication with the merchant server.

24-26. (canceled)

27. A method comprising:
by an apparatus comprising a body carriage having rotatable wheels mounted thereunder, the rotatable wheels configured to roll along a surface of a pavement, each of the rotatable wheels including a tire mounted on a rim, wherein an outer surface of the rim and an inner surface of the tire define an inner space there-between, and a mobile payment extension system including a plurality of road contact modules mounted on the outer surface of the rim of at least one of the rotatable wheels and configured so that the plurality of road contact modules protrude away from the outer surface of the rim and into the inner space, the plurality of road contact modules configured so that at least one of the plurality of road contact modules is no more than a predetermined distance from an in-pavement vehicle detection system embedded on or below the surface of the pavement when the tire of the at least one of the rotatable wheels is positioned on the surface of the pavement, the mobile payment extension system configured to communicate wirelessly with a merchant system via the in-pavement vehicle detection system and configured to receive one or more personal settings from the personal mobile communication devices and to store the one or more personal settings:
receiving an input from a user of the personal mobile communication device; and
determining a screen layout for a user interface on the personal mobile communication device, the screen layout including at least a menu bar and icon placement rendered on the personal mobile communication device, the screen layout determined based on:
a user profile setting stored in an extension circuitry module of the apparatus;
a merchant type; and
a customer identity dynamically extracted from the user's personal mobile communication device.

28. A non-transitory computer-readable storage medium storing one or more programs configured to be executed by one or more processing units at a computer comprising instructions for:
by an apparatus comprising a body carriage having rotatable wheels mounted thereunder, the rotatable wheels configured to roll along a surface of a pavement, each of the rotatable wheels including a tire mounted on a rim, wherein an outer surface of the rim and an inner surface of the tire define an inner space there-between, and a mobile payment extension system a plurality of road contact modules mounted on the outer surface of the rim of at least one of the rotatable wheels and configured so that the plurality of road contact modules protrude away from the outer surface of the rim and into the inner space, the plurality of road contact modules configured so that at least one of the plurality of road contact modules is no more than a predetermined distance from an in-pavement vehicle detection system embedded on or below the surface of the pavement when the tire of the at least one of the rotatable wheels is positioned on the surface of the pavement, the mobile payment extension system configured to communicate wirelessly with a merchant system via the in-pavement vehicle detection system and configured to receive one or more personal settings from the personal mobile communication devices and to store the one or more personal settings:
receiving an input from a user of the personal mobile communication device; and
determining a screen layout for a user interface on the personal mobile communication device, the screen layout including at least a menu bar and icon placement rendered on the personal mobile communication device, the screen layout determined based on:
a user profile setting stored in an extension circuitry module of the apparatus;
a merchant type; and
a customer identity dynamically extracted from the user's personal mobile communication device.

29. The apparatus of claim 1, wherein the personal mobile communication device comprises a smartphone or tablet.

30. The apparatus of claim 1, wherein the extension circuitry module comprises one or more NFC chips embedded in the apparatus, the one or more NFC chips comprising:
an identity of the apparatus; and
an identity of the user.

31. The apparatus of claim 7, wherein the specified types of information from the merchant comprises one or more advertisement messages.

32. The apparatus of claim 22, wherein the screen layout for each of the users is unique.

33. (canceled)

34. The apparatus of claim 1, wherein the screen layout is further determined based upon a location of the apparatus.

35. The apparatus of claim 31, wherein the advertisement messages from the merchant are based at least in part on:
identifying information regarding the user or the user's apparatus; and
a type of products or services that the user has just ordered.

36. The apparatus of claim 35, wherein the advertisement messages from the merchant are further based at least in part on a location of the merchant.

37. The apparatus of claim 35, wherein the identifying information regarding the user's apparatus comprises:
a model and make of the apparatus;
an age of the apparatus; or
a type of tires on the apparatus.

38. The apparatus of claim 1, wherein the mobile payment extension system is configured to permit two or more simultaneous sessions with two or more personal mobile communication devices.
